(19) United States
(12) Patent Application Publication
(10) Pub. No.: US 2008/0071664 A1
(43) Pub. Date: Mar. 20, 2008

(54) Limiting Counter-Party Risk in Multiple Party Transactions

(75) Inventors: David L. SILVERMAN, St. James, NY (US); Timothy J. DOAR, Oak Park, IL (US); Edward M. GOGOL, Skokie, IL (US)

Correspondence Address: BANNER & WITCOFF, 1100 13th Street, Suite 1200, WASHINGTON, DC, 20005-4051, US

(73) Assignees: REUTERS AMERICA, INC., New York, NY (US); CHICAGO MERCANTILE EXCHANGE, INC., Chicago, IL (US)

(21) Appl. No.: 11/532,669

(22) Filed: Sep. 18, 2006

(51) Int. Cl. G06Q 40/00

(52) U.S. Cl. 705/37

(57) ABSTRACT

A computerized entity, system and method for limiting or eliminating counterparty risk for settlement in financial transactions are described. A central counterparty novates trades between counterparties and interposes itself as the entity with whom each counterparty will settle. The central counterparty may require additional credit or collateral from one or more counterparties to ensure that the central counterparty does not assume an unaddressed risk.

### BACKGROUND

Aspects of the present invention relate to computerized devices, systems and/or methods for limiting certain types of risk in multi-party transactions.

The trading of most financial instruments can generally be separated into two groups: those that are traded on an exchange and those that are not. Although, some instruments may be traded both on and off-exchange. The exchange-traded instruments have seen tremendous growth in recent years, due in part because of the ease of trading and the limited settlement risk borne by the parties to the transaction.

One of the primary impediments to migrating non-exchange traded instruments to an exchange is the complexity of risk management for all parties involved. Trading in financial markets can involve different types of risk. “Market risk” is the risk that the value of investments will change unexpectedly due to movement in prices. “Liquidity risk” is the risk that a holder of an investment will not be able to find a buyer at the moment he desires to sell. “Counterparty risk” is the risk that the counterparty to a transaction will unexpectedly not fulfill his or her obligations to the transaction.

Some non-exchange traded financial transactions (known as “over-the-counter transactions” or “OTC transactions”) can have huge levels of counterparty risk. In these types of transactions, the failure of a counterparty to fulfill its obligations can result in huge financial exposures to the opposite party in a transaction. Because of this high counterparty risk, OTC markets have effectively been limited to only those parties who have sufficient credit and/or track records to guarantee that they will fulfill their settlement obligations. Even if a new party were to attempt to trade in OTC instruments, the new party could be shunned until it garnered the respect (and credit rating) of other parties and/or provided proof to a counterpart of sufficient collateral guaranteeing that it would settle according to the conventions of the OTC market. This added credit hurdle prevents newer entities from easily entering these OTC markets, thereby limiting the growth of OTC markets.

### SUMMARY

This summary is provided to introduce a selection of concepts in a simplified form that are further described below in the Detailed Description. This summary is not intended to identify key features or essential features of the claimed subject matter.

Aspects of the present invention address one or more issues described above, thereby minimizing or eliminating counterparty risk for traditionally non-exchange traded instruments.

In some aspects of the invention, a central counterparty novates trades between counterparties, thereby substituting the original transactions with transactions between the original counterparties and the central counterparty.

Other aspects of the present invention relate to determining and/or minimizing risk to the central counterparty for novating the transactions between counterparties and assuming the settlement obligations for a previous counterparty. Other aspects of the present invention relate to reducing the possibility of error, and therefore risk, by providing a fast, end-to-end, electronic pathway for the handling of transactions.

These and other aspects of the disclosure will be apparent upon consideration of the following detailed description of illustrative embodiments.

### BRIEF DESCRIPTION

A more complete understanding of the present invention and the potential advantages thereof may be acquired by referring to the following description of illustrative embodiments in consideration of the accompanying drawings.

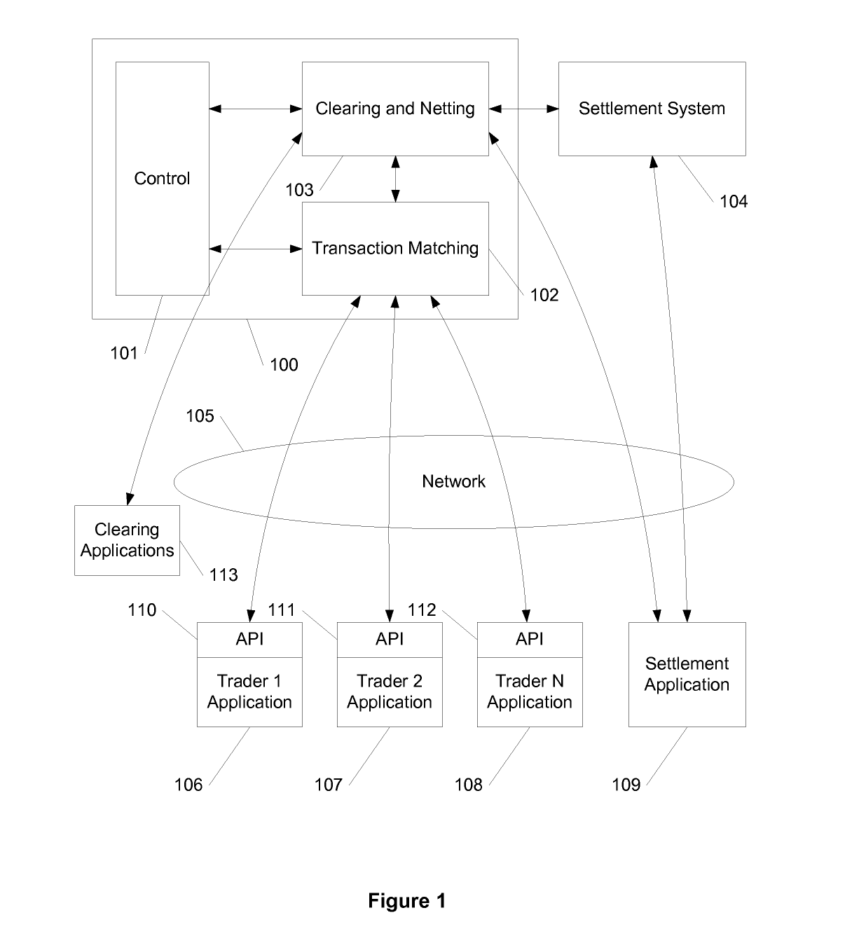

FIG. 1 shows a general overview in accordance with aspects of the present invention.

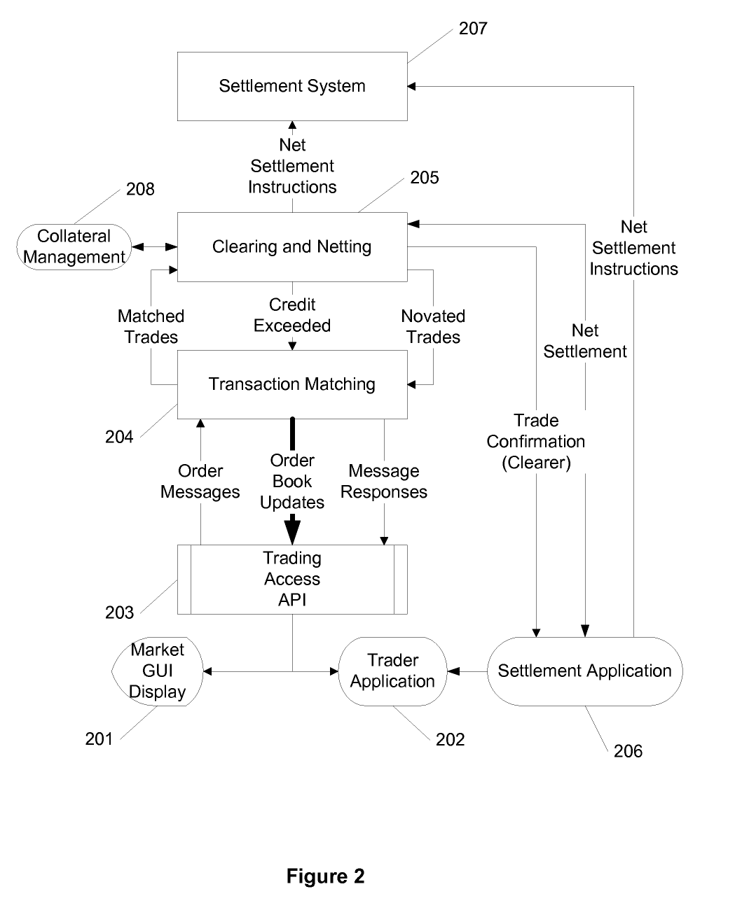

FIG. 2 shows various message flows and interfaces in accordance with aspects of the present invention.

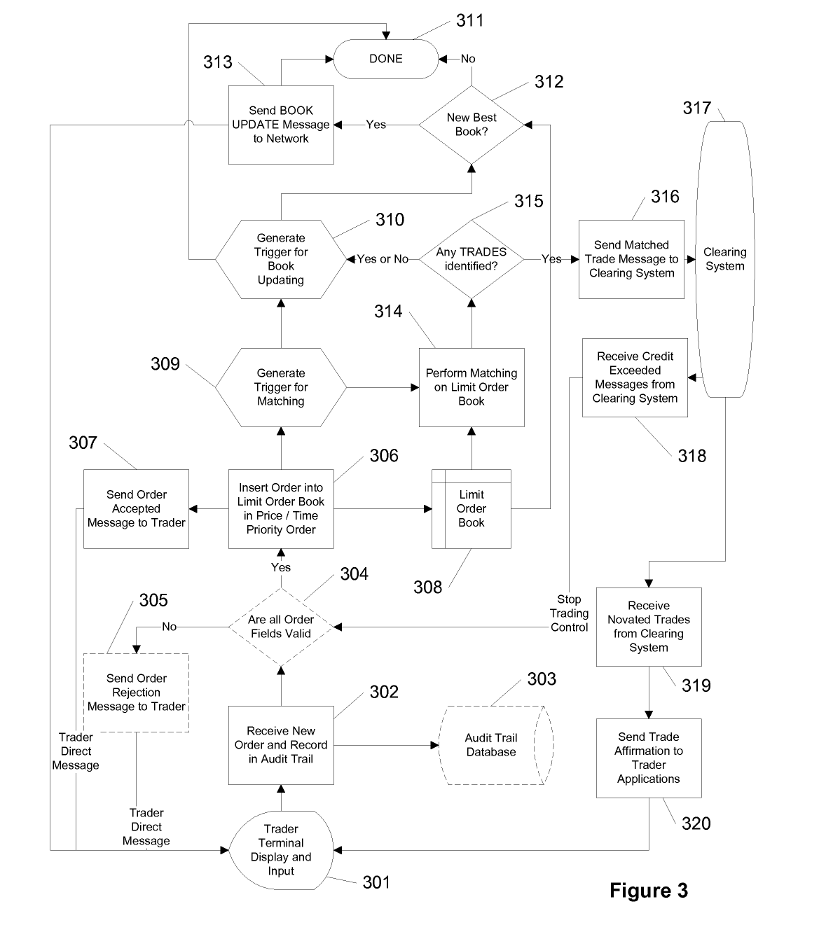

FIG. 3 shows various message flows and interfaces regarding order validation, matching, and order book updating in accordance with aspects of the present invention.

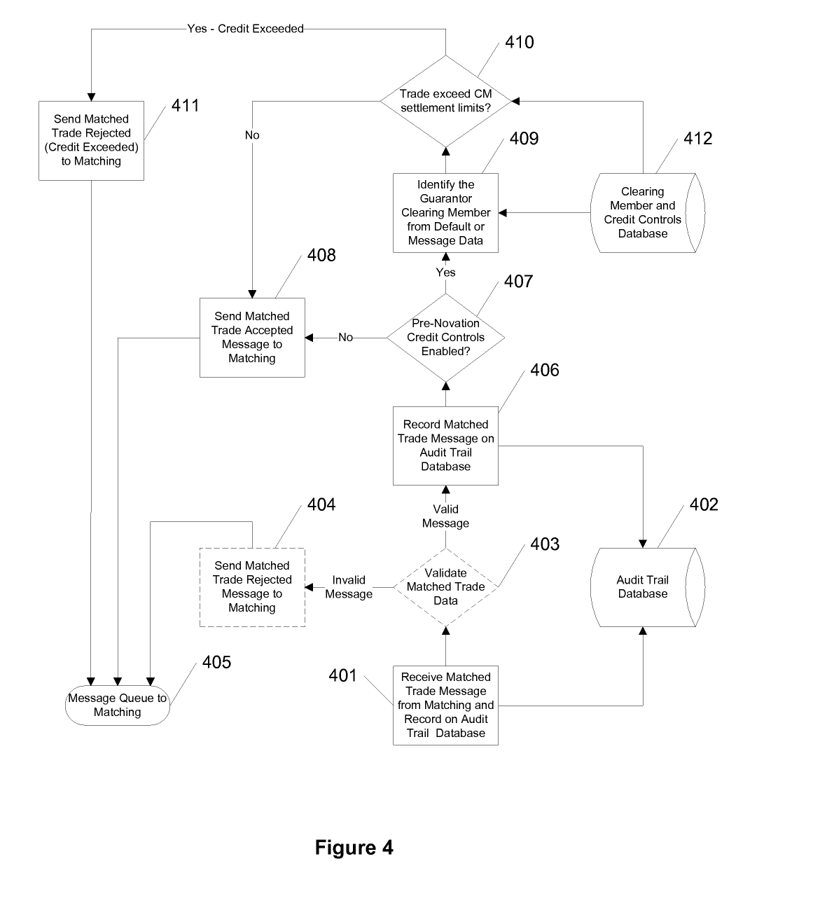

FIG. 4 shows various message flows relating to matched trade novation with settlement limit control in accordance with aspects of the present invention.

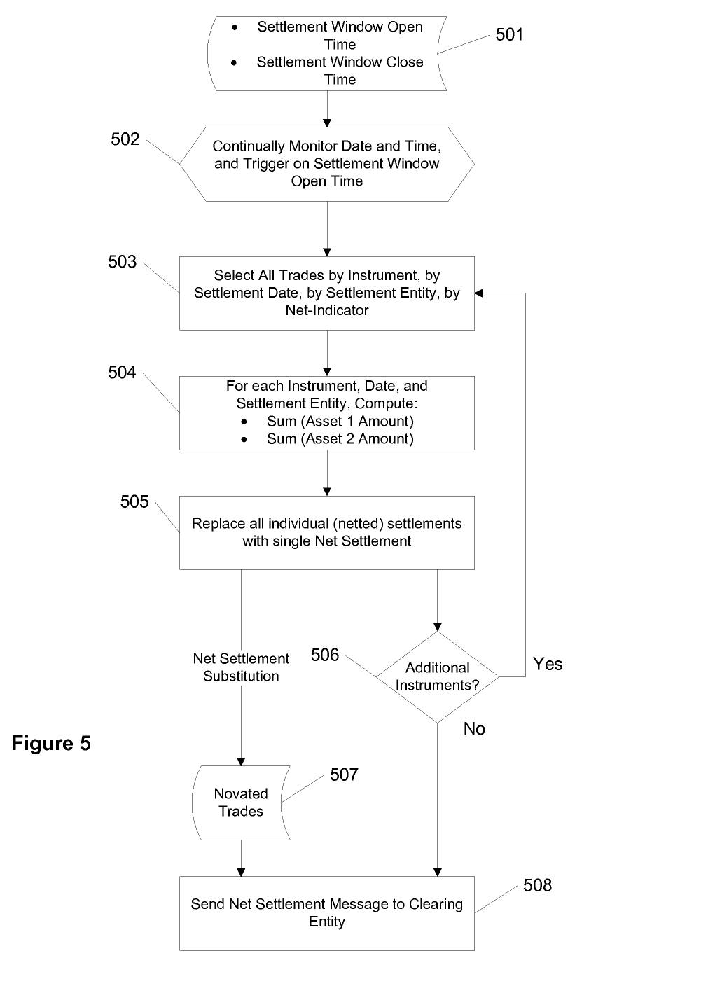

FIG. 5 shows various message flows in accordance with pre-settlement trade netting with trade substitution in accordance with aspects of the present invention.

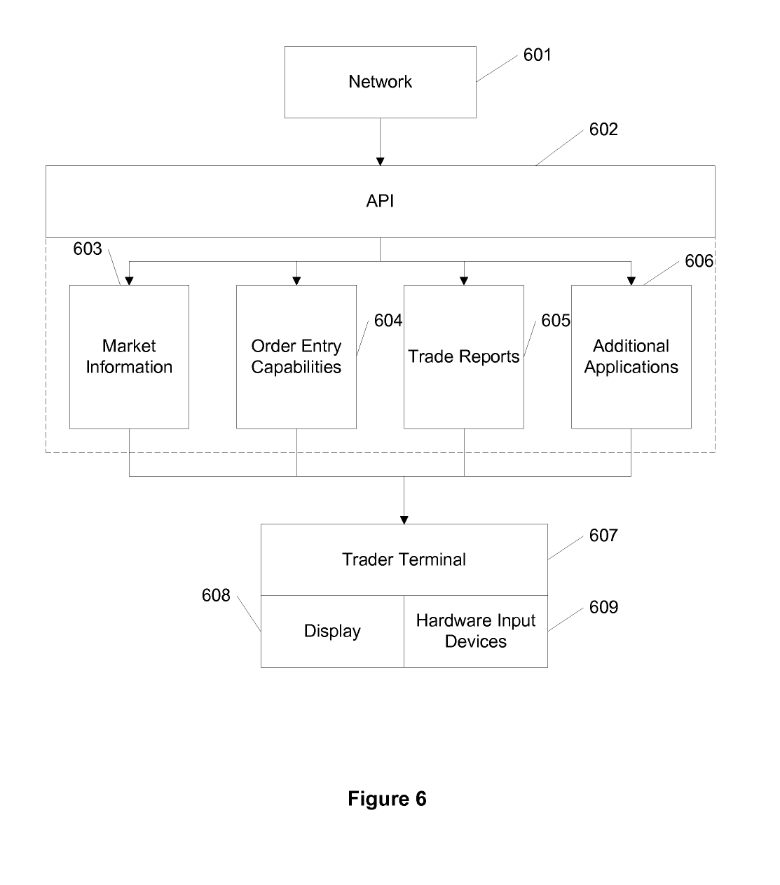

FIG. 6 shows an application programming interface and trader terminal that may be used in accordance with aspects of the present invention.

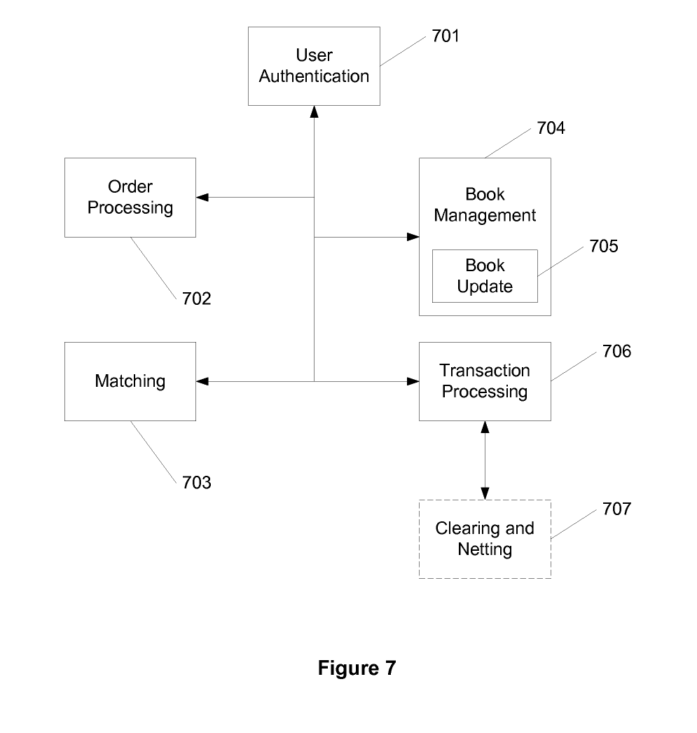

FIG. 7 shows various functional components of the transaction matching system in accordance with aspects of the present invention.

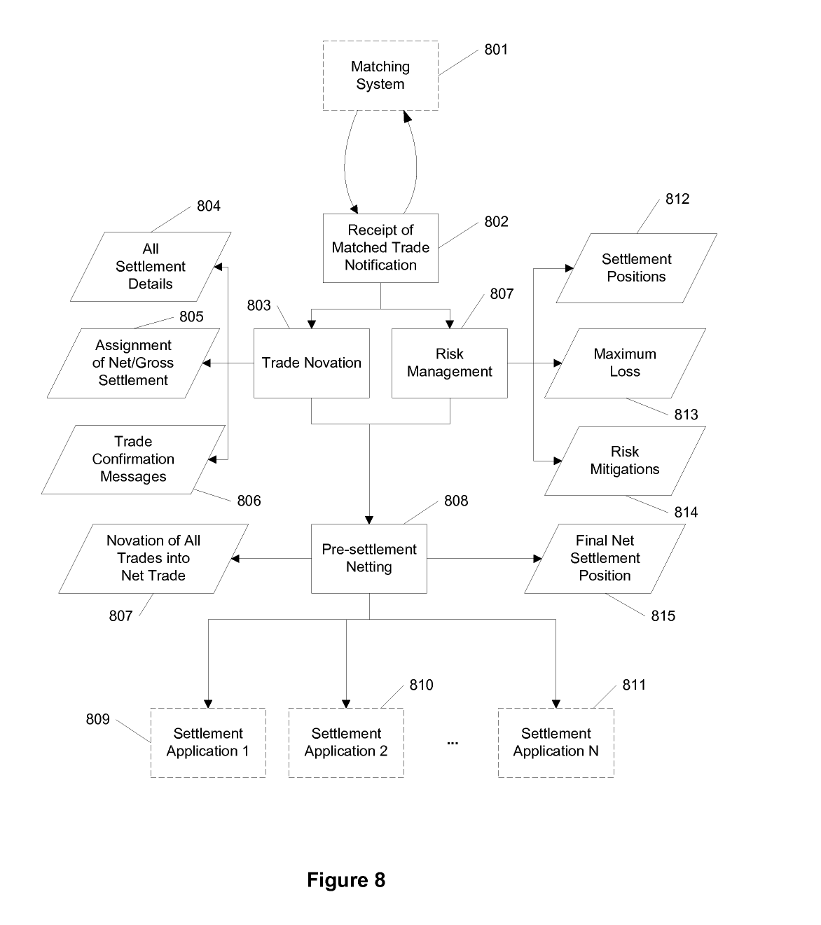

FIG. 8 shows clearing and netting components in accordance with aspects of the present invention.

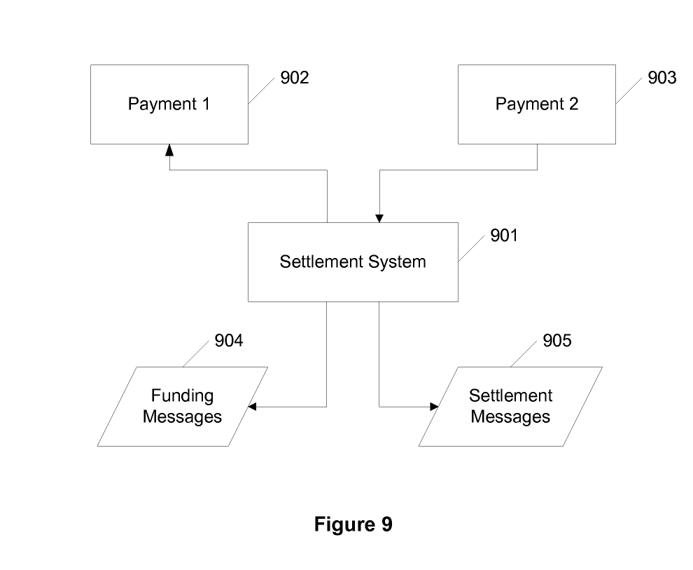

FIG. 9 shows a settlement system in accordance with aspects of the present invention.

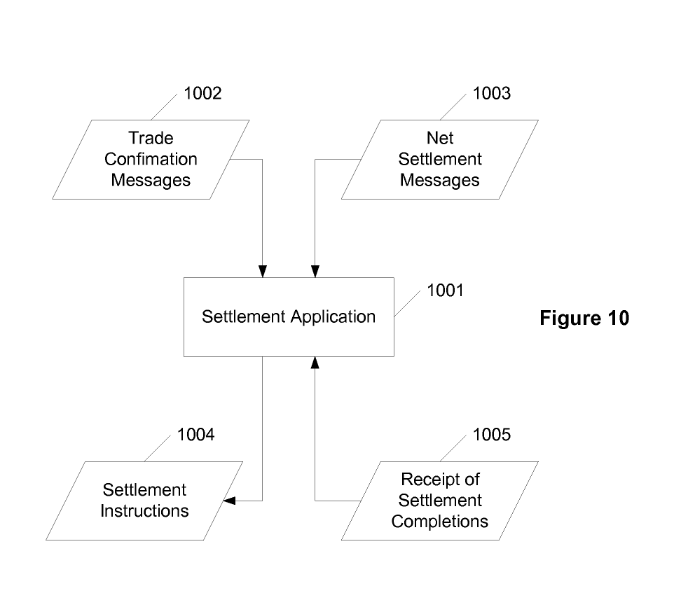

FIG. 10 shows a settlement application in accordance with aspects of the present invention.

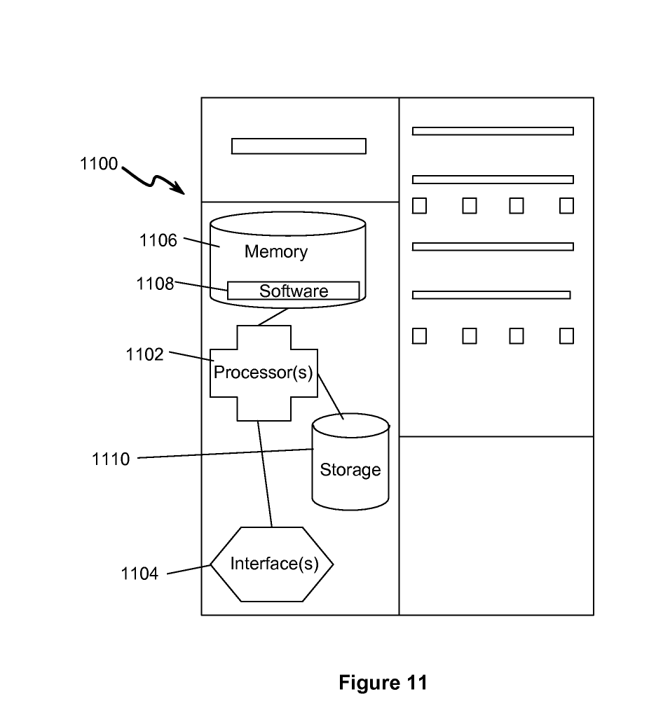

FIG. 11 shows a functional block diagram of an example computing entity of the overview system FIG. 1.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

The following description is divided into subsections to assist the reader. These subsections are included for illustrative purposes only as aspects of the invention may include one or more of the components, processes, and APIs described below:
1. Conventional Trading Processes
2. Exchange Markets and Over-the-Counter Markets
3. Counterparty Risk
4. Timing of Counterparty Risk
5. Trading Processes with Novation
6. Trader API
7. Transaction Matching
8. Clearing and Netting
9. System-associated Settlement System
10. Trader-associated Settlement Application
11. Examples

### 1. Conventional Trading Processes

In general, financial markets have three primary steps in their trading processes: Market Price Discovery, Transaction Execution, and Transaction Settlement.

Market Price Discovery is the process by which an executable Bid (the price at which someone is willing to buy) and an executable Offer (the price at which someone is willing to sell) are created and disseminated to market participants. In general terms, this process involves the collection of a “central limit order book” of bids and offers from all participants active in the market place. The term “all participants” generally refers to those who are interested in buying or selling a particular instrument. The central limit order book (also referred to as “the book” or “the CLOB”) is arranged according to the rules of the market in a “price-time priority” sequence. This gives priority to the highest Bids and lowest Offers. This priority ordering also resolves ties in price by sequencing according to time. In short, the first highest Bid has priority over all other bids in the marketplace. In almost all cases, the book of bids and offers is anonymous, meaning that the identity of bidders and offerors is not revealed to market participants prior to a trade. Other variations on CLOB sequencing are possible, for example Prize/Size/Time priority, in which larger orders have priority over smaller orders of the same price, even if they arrived later in time. The operator of the market typically determines the priority sequencing rules of the CLOB based on the requirements of the marketplace, in order to maximize liquidity and encourage involvement of the largest number of participants. In some markets a central regulatory authority may dictate the priority rules of the CLOB.

Markets may include a number of participants. The participants are not always equal, however, in the eyes of other market participants. Depending on the characteristics of a particular market, not all bids and offers are always available for trading to any particular participant. For example, a seller of securities may only want to sell to an institution, and not to a private individual. Or a buyer of foreign currency may not be able to settle with a foreign institution, so his bid is limited for access by domestic counterparties.

To account for these limitations on the trading abilities for a given market participant, the market price discovery process may filter the book of bids and offers so that participants can only see those orders (bids and offers) that are actually available to them for transacting. The filtering process must take account of any limitations imposed by the bidder or offeror, and any limitations imposed by the recipient. This is known as bi-lateral filtering.

Transaction Execution is the process by which a bidder and an offeror (a buyer and a seller) are matched by a broker in order that they may complete a transaction. The matching process is typically performed by a computer in active markets, but it may be performed by a human being (a so-called “voice broker”) in some markets. When an order is fully matched, it is removed from the book so that other participants do not mistakenly believe the order is still available for transacting. In some cases, the process of Transaction Execution involves additional steps of negotiation in case the full detail of the intended transaction is not captured simply by the price that was revealed in price discovery. For example, it may be necessary for the transacting parties to agree on settlement dates, on quantity, on reference prices, and so forth. These parameters to a trade may not have been conditions on the original bids and offers and, hence, could not be matched prior to bringing the two parties together.

Once two parties have agreed to execute a trade, they are obligated to one another to complete the settlement of the transaction. The settlement process is the procedure used to effect the actual exchange of value between the parties. For example, in a securities transaction, a buyer and a seller agree to trade, e.g., 1000 shares of stock X at a price of $10 per share. This transaction is scheduled for settlement three days after the trade date. On or before the settlement date, the seller must make arrangements for delivery of 1000 shares of stock to the buyer and the buyer must make arrangements for delivery of $10,000 to the seller. Once both of these exchanges are complete, the transaction is said to have been fully settled.

In some complex financial transactions, the settlement may actually take place on multiple dates. For example, in an Interest Rate Swap the parties agree to exchange payments every six months over a period of possibly several years. In a Foreign Exchange swap, a first settlement occurs two days following the transaction and a second settlement occurs anywhere from three days to a year or more later.

### 2. Exchange Markets and Over-the-Counter Markets

Different instruments are traded in different marketplaces. For example, stocks typically trade on an organized exchange, whereas interest rate derivatives and foreign currencies typically trade without the central facilities of an exchange. These distinctions are very relevant to the subject addressed by the current invention.

In an exchange-traded market, a central exchange provides a number of services to the marketplace that ensure orderly conduct of business and eliminate (or transfer) some forms of risk away from market participants. For example, in a market with specialists there is far less liquidity risk, since one of the functions of the specialists is to ensure that there is always a reasonable bid price and offer price available to participants. In this case liquidity risk is transferred away from market participants and into the specialists, who may be obligated to hold illiquid positions until they can transfer them into the marketplace. In almost all exchange markets, the exchange acts as a “central counterparty” for every trade: it interposes itself between the buyer and the seller so that the exchange itself guarantees the settlement of the transaction rather than the individual participants. This process of interposing a third party between buyer and seller is also known as trade novation to a central counterparty, or simply as “novation.” Since the exchange incurs risk as a consequence of its guarantee, the novation process typically limits direct exchange access to established, creditworthy members, and insists that the general public only access the exchange through services provided by exchange members.

Over-the-counter markets do not benefit from the functions provided by an exchange. Conversely, the over-the-counter markets do not have many of the same limitations associated with exchange access. Typically, any sufficiently creditworthy participant (as determined by the judgment of other market participants) is able to interact in an OTC financial market. There is no central counterparty guaranteeing liquidity or settlement, so it is incumbent on OTC market participants to settle their trade obligations directly. This is known as “direct settlement” versus “exchange settlement”.

Depending on the conventions of the particular market, there is typically a span of several days between the trade date and the intended settlement date. For example, in the foreign exchange market, trades in most currencies settle on a minimum of two business days following the trade date (excepting for weekends and holidays). During this period between trade and settlement, there is an expectation on both counterparties that they effectively own the commodity (if they are the buyer) or have sold the commodity (if they are the seller) even though there is not an absolute certainty that the trade will, in fact, settle on the expected terms. A number of factors could theoretically cause the trade to fail to settle. Some of these factors are listed below:
1. Bankruptcy of the counterparty prior to settlement
2. Operational error which causes a counterparty to be unaware of the settlement obligation
3. Liquidity problems which cause a counterparty to be unable to fund the settlement at the required time
4. System malfunctions that render a counterparty unable to provide the necessary instructions for settlement

In all these cases, and others, the party that fulfills settlement obligations is exposed to significant risk. Since this risk is a function of the actions or inactions of the counterparty, this risk is collectively known as “counterparty settlement risk”. All OTC markets have intrinsic counterparty settlement risk since the successful completion of transactions is dependent upon the correct and timely actions of both parties to the trade. Counterparty risk is distinct from the other types of risks (including market risk, liquidity risk, regulatory risk, and other forms of risk).

### 3. Counterparty Risk

Counterparty risk is the possibility of unexpected losses stemming from the actions (or inactions) of a counterparty to a trade. The following describes three types of counterparty risk. Aspects of the present invention may minimize (and/or eliminate) one or more of these types of counterparty risk:
1. Insufficient Credit to Settle: Occasionally, following a trade being executed by a broker or electronic platform, a party to the trade discovers that it did not, in fact, have sufficient credit lines to transact with the other party. In effect, the trade should not have taken place and the party is required to break the trade with the other party since the party is unable to settle. This should be a rare occurrence but it does happen in some markets.
2. Failure to Instruct Settlement: There are numerous possible sources of operational error in the post-trade, pre-settlement process. Transactions may be lost due to technical malfunctions; transactions may be transcribed through a manual process that introduces errors; disasters of both a natural and man-made variety may occur that interfere with orderly settlement. In these cases and others, one party to a trade may not send the appropriate instructions to correspondent banks to transfer funds and assets on the settlement day.
3. Failure to Settle: Finally, there is a real possibility that one party to a trade actually settles his or her obligations and the other party does not. This can be exacerbated in markets that require one party to settle prior to another party. The failure to settle can be “benign” (i.e. caused by an inadvertent error), be malicious (i.e. a party elects not to settle due to what it believes was a trading error), or simply a very bad trade. In the most extreme cases, the failure to settle can give rise to gross settlement risk, i.e. the complete loss of principal where one party has paid the other but the other is unable or unwilling to pay its side of the transaction.

Counterparty risk can prevent parties from entering into transaction, thereby slowing or impeding the growth of a market. In at least one aspect of the present invention, a central counterparty is used to place itself between parties to absorb the counterparty risk. The central counterparty can then adjust its practices to account for possible loss from any given counterparty.

### 4. Timing of Counterparty Risk

The participants in a trade are potentially exposed to counterparty risk from the moment the trade is executed, up through and including final settlement of all obligations. Trades may be classified into two classes of transactions depending on whether the transaction involves a single settlement or the transaction involves multiple settlements.

Single-Settlement Transactions are those that require a single exchange of value between buyer and seller in order to be complete. Examples of single-settlement transactions include security (stock and bond) transactions, most commodity transactions, Spot Foreign Exchange transactions, and Forward Rate Agreements.

Multi-Settlement Transactions are those that require more than one, and sometimes an entire series of settlements before they are complete. Examples of two-settlement transactions include Forward Exchange Swaps, Cross-Currency Interest Rate Swaps, and some Repurchase Agreement transactions. Examples of multi-settlement transactions are Long Term Interest Rate Swap agreements, which may have a settlement every three or six months for the multi-year life of the agreement.

There are three primary windows of potential counterparty risk:
1. Between Trade Execution and Trade Confirmation
2. Between Trade Confirmation and Settlement
3. Between Initiation of Settlement and Completion of Settlement

Trades can be executed by individual traders using trading terminals, or by proprietary programs that execute trades on behalf of trading institutions. The trade execution causes a message to be sent shortly thereafter to the two parties of the trade. However, an additional message must also be delivered to the party responsible for settlement of the resulting obligation. Oftentimes the settlement party is the same as the trading party, but they may be different departments within the same organization, different physical locations, or even different institutions altogether. If a trade has been executed, but the settlement entity does not receive the trade confirmation, there is a window of risk and a possibility that the trade will not settle as expected. In at least one aspect of the present invention, this window of risk is addressed by ensuring that all executed trades are notified to the appropriate settlement entity in a timely fashion.

If the trade has been notified to the trading entity and the settlement entity, there is still the possibility that in the time window between trade confirmation and final settlement the settlement entity will fail to provide instructions to its banking agents for settlement of the trade obligation. This can occur due to operational errors, due to liquidity problems, due to bankruptcy, or any of a large number of other reasons which might cause a firm to decide that it cannot settle its outstanding obligations. In at least one aspect of the present invention, this form of risk is addressed by ensuring that the worst-case losses that might transpire from failure to instruct settlement are measured and/or insured through one or more mechanisms (e.g. collateral or insurance). This is sometimes referred to as “clearing”.

Finally, it is possible for a firm to instruct a trade for settlement, but then fail to provide the funds or assets required for the settlement transaction. In this case, if the two payments constituting an exchange of value are not irrevocably linked, then it would be possible for one party to pay but not to receive the expected value, resulting in a possible loss of entire settlement value. In at least one aspect of the present invention, this possibility of loss is addressed through use of settlement systems that provide a “payment versus payment” or “delivery versus payment” model for exchange of value. In such systems it is impossible to pay one half of a settlement and not receive the corresponding other half. One or more aspects of the present invention use these types of settlement mechanisms to protect the central counterparty from gross settlement risk.

Finally, in order to minimize risk of human error, aspects of the present invention may minimize and/or eliminate human intervention. In some aspects of the present invention, the systems and methods described herein can use expedited processing techniques to ensure that trades can settle on very short settlement schedules, potentially same-day or next-day, without introducing the inherent risks of human or paper-based processing. By narrowing time windows and eliminating human processing this invention ensures that the opportunities for introducing risk are absolutely minimized.

### 5. Trading Processes with Novation

FIG. 1 relates to a system that integrates a number of processes that handles both trading and settlement in marketplaces that were previously constrained by counterparty risk. The processes include:
1. Price Discovery
2. Transaction Execution
3. Trade Novation
4. Post-Trade Pre-Settlement Risk Management
5. Pre-Settlement Netting
6. Delivery versus Payment Settlement

Although described in the context of foreign exchange transactions in a wholesale marketplace, the principles of the invention apply equally well to other financial markets (e.g. securities, bonds, interest rate derivatives, commodities, energy) and to other classes of participant (e.g. non-bank financial institutions, non-financial corporations, individual persons).

FIG. 1 shows a general overview in accordance with aspects of the present invention. FIG. 1 shows a central counterparty 100 and systems that exchange information with the central counterparty 100. Optionally, settlement system 104 may or may not be part of the central counterparty 100. The central counterparty may include a control system 101, a transaction matching system 102 and a clearing and netting system 103.

Traders may trade with each other using trading terminals. The trading terminals may include a trader application (106-108) that handles the local display of trading information and accepting and forwarding actions from a trader. The trading terminals may include dedicated trading computers, general purpose computers running a local trading application, a computer, or other computing system that provides an internet-based, and combinations there between. Further, the trader applications may optionally be a “black-box” that performs algorithmic trading without local display or actions from a trader.

For purposes herein, the functionality that receives information from a trader and provides information to a trader is referred to as a “trader application”, represented in FIG. 1 by trader 1 application 106, trader 2 application 107, and trader N application 108. The trader applications 106-108 may execute on a computer located at each market participant (trader) location. The trader application 106-108 may be a program that provides a graphical user interface (GUI) with trading functionality, an automated program trading application, or a hybrid of these two programs. The trader may enter trade order messages in the trader applications 106-108 in response to a viewed order book. Also, the trader may specify on each trade individually or as a default whether the trades should be settled in gross or in net.

Each trader application 106-108 communicates (directly or indirectly) with a transaction matching system 102 via a network 105. For instance, network 105 may be a wide area network or any other type of network. The network 105 may be the public internet, a privately managed TCP/IP network, or any other form of communications network that allows trading applications to communicate at high speed, and with low latency, with the transaction matching system of FIG. 1. The trader applications 106-108 may communicate with the transaction matching system 102 using application programming interfaces (APIs) 110-112.

The trader applications 106-108 may specify whether gross/net settlement is desired based on one or more factors including the size of the trade (for instance, nominial settlement amounts may be settled in gross or netted together), trades increasing a risk to a party, and/or other difficulties to the trader.

Next, the transaction matching system 102 matches trades from the traders and provides an indication of a match to the trader applications 106-108. The transaction matching system 102 may be a computer system that is responsible for processing quotes and orders submitted by trader applications 106-108, and assembling these orders into a central limit order book for display to all market participants. By assembling the orders into a central limit order book, the transaction matching system 102 provides traders with a book of the best prices where participants can transact in the marketplace (also referred to herein as “price discovery”). As described below, there is minimal to no counterparty friction in the system of FIG. 1, allowing all orders to be shown to all participants. In other words, there is no filtering of orders from the central order book.

The transaction matching system 102 can also be responsible for the actual matching process, i.e. identifying pairs of orders which can match according to the rules of Price and Time Priority, or such other matching rules as are implemented for the particular marketplace.

The transaction matching system 102 may forward the match indication to clearing and netting system 103, where the match is cleared and payments or deliverables from the traders are determined.

The functionality of the central counterparty 100 performing a novation of a trade and assuming the responsibilities of the counterparties may be performed by the clearing and netting system 103. The clearing and netting system 103 may include a computer system and/or program that acts as the central counterparty to every trade which is reported by the transaction matching system 102 above. When the transaction matching system 102 notifies the clearing and netting system 103 of a matched (executed) trade, the clearing and netting system 103 immediately interposes itself between the buyer and the seller, and novates the trade into two equal, but opposite trades with the central counterparty 100 (or more particularly, the clearing and netting system 103) in the middle. The clearing and netting system 103 novating trades between trading entities eliminates counterparty risk between traders since those traders are no longer dependant on the performance of the original counterparty.

The clearing and netting system 103 then generates Trade Confirmation messages, which are sent to the respective clearing agents for the buyer and seller (settlement applications 109 and/or clearing applications 113), with all settlement details contained therein. Finally, the clearing and netting system 103 may continually measure the total settlement exposure (both gross and net) with each settlement entity, and ensure that adequate financial safeguards (e.g. collateral) are in place to protect the central counterparty 100 from all losses in case any settlement entity should fail to settle its obligations with the central counterparty.

On each settlement day, the clearing and netting system 103 may send settlement instructions to the settlement system 104 to cause receipt and payment of its settlement obligations. The settlement system 104 may be responsible for actually effecting the transfer of funds from the central counterparty 100 to and from the marketplace participants. It performs this function based on receiving and matching settlement messages from the clearing and netting system 103 (on behalf of the central counterparty 100), and from the multiplicity of clearing applications 113 (on behalf of marketplace participants). The settlement system 104 can perform all settlements on a fully funded, “payment versus payment” or “delivery versus payment” basis, thereby eliminating gross settlement risk for the market participants. The settlement system 104 does not perform any netting although it may net the funding requirements of a set of trades. Rather, the settlement system 104 settles trades in accordance with its instructions.

Further, the settlement system 104 respects the wishes of a party regarding whether a trade should be settled in gross or in net.

The clearing applications 113 may or may not have the ability to alter parts of a transaction. For instance, clearing applications 113 may optionally change the gross/net instructions of the market participants if necessary to reduce settlement risk of a third party within acceptable bounds.

The settlement applications 109 relate to the settlement entity that obtains and provides settlement obligations on behalf of a market participant. End user organizations need to be notified of their net settlement obligations, and instruct their settlement banks to effect payment of these obligations. A communications channel between the clearing and netting system 103 communicates with the customer settlement applications 109 for this purpose. The settlement applications 109 receive Trade Notification messages and Net Settlement Notification messages from the clearing and netting system 103. The settlement applications 109 next transmit settlement instructions to the settlement system 104. In effect, the settlement application 109 performs similar computations as the clearing and netting system 103, but is limited to the trades of a single entity.

The above description relates to the physical connections between the components shown in FIG. 1. The various processes performed by the components of FIG. 1 are described below.

Trader applications 106-108 are available to market participants. Using the Trader applications 106-108, traders enter bids and offers, cancel unmatched, open orders, and perform such other transactions as are permitted on the marketplace.

The trader applications 106-108 may display a central order book. The central order book may be dynamically updated with the bids and offers available in the marketplace. The display may be updated in real time as new orders are received by the marketplace. The trader applications 106-108 may also display and store a record of all executed transactions that are reported by the central marketplace for a single trading workstation and/or a single trader.

The transaction matching system 102 receives the orders and cancellations from all trader applications 106-108 of the system, and organizes these orders into a central order book according to the priority rules of the marketplace.

Network 105 provides a medium through which the central order book is provided to all market participants. Network 105 may provide a high speed, low latency connection between trader applications 106-108 and transaction matching system 102.

The transaction matching system 102 may perform a number of functions. For instance, the transaction matching system 102 matches bids and offers, or buy and sell orders, according to the rules of the marketplace, removes such matched bids and offers from the central order book, and notifies the trader applications 106-108 which originated the matched bids and/or offers of the resulting trade executions as described above.

The clearing and netting system 103 receives matched trades from transaction matching system 102. The transaction matching system 102 may send all matched trade notification signals to the clearing and netting system 103 at the same time as or before the matched trade notifications are sent to trader applications 106-108. One advantage of sending matched trade notification signals to the clearing and netting system 103 first is that the clearing and netting system 103 can then confirm receipt of the matched trade notification signals to the transaction matching system 102 before the sending of matched confirmation signals to the trader applications 106-108 by the transaction matching system 102. Additionally, this provides an opportunity for the clearing and netting system 103 to perform various limit checks on the matched trade before accepting it and notifying it to the trader applications.

Each side of the trade may be associated with an individual trader entity (for instance, the trader that submitted the bid or offer) for settlement. Alternatively, each side of the trade may be associated with a different entity, for instance settlement application 109, that handles the settlement obligations on behalf of the trader. The settlement application 109 may then be responsible for settling the trade with the central counterparty on behalf of the trading entity (e.g., the trader) and separately settling with the trading entity.

Some traders and/or trading entities may be very active on any given day. These trading entities may be unable to conduct favorable trades due to the limitations of pending settlements. For instance, if a trading entity was required to settle each trade in gross, it may not have enough liquidity to cover a first transaction if the first transaction was settled prior to a second transaction. However if the two transactions were “merged” into one then they might be offsetting and generate profits for the trader. Accordingly, in at least one aspect of the present invention, a trader may elect to settle in net as opposed to settling in gross. Alternatively, and optionally, the trader may elect to settle in gross as compared to a net settlement.

Next, a confirmation is sent from clearing and netting system 103 to the transaction matching system 102 that the clearing and netting system 103 has received the trade notification. A confirmation from the clearing and netting system that it has received the trade notification means that it is safe to notify the buyer and seller, or their respective clearing entities, of the resulting trade obligation. The message from clearing and netting system 103 is the formal notification that the matched trade has been novated, i.e. accepted by the central counterparty for settlement.

Additionally, a separate message from the clearing and netting system 103 may be sent to each sent to each of the traders' (or their clearing agents') settlement applications 109, informing the settlement applications 109 of the settlement obligation resulting from the executed trade. In at least one aspect of the present invention, the message from the clearing and netting system 103 to the settlement applications 109 may be performed prior to clearing and netting system 103 confirming its receipt of a matched trade from transaction matching system 102. Accordingly, in this aspect of the present invention, the traders may be the last entities informed of a successful match, thereby ensuring settlement applications 109 acknowledged the receipt of the matched trade first.

Further, the clearing and netting system 103 may include a process that periodically (or continually) computes the net settlement obligation between the central counterparty and each of the participants in the marketplace. The net settlement obligation may be computed for each instrument and each settlement date.

The clearing and netting system 103 may further transmit the net settlement obligation to the settlement applications 109 of the marketplace participants and/or the settlement system 104. This transmission may occur on a per instrument basis once the net settlement obligation has been computed. Further, after trading closes on any given settlement date, the clearing and netting system 103 may forward a final net settlement obligation to each settlement entity (settlement applications 109 and settlement system 104).

Optionally, the clearing and netting system 103 may include a process that ascertains the change in market value of the settlement positions for each settlement entity (settlement applications 109 and settlement system 104) on the system. This process may compute the worst case loss for the central counterparty if any settlement entity should fail to settle all or some of their trade obligations on settlement day. Optionally this computation may be done on a trading entity basis, a clearing entity basis, or a settlement entity basis.

Further, the clearing and netting system 103 may insure that sufficient collateral has been provided by each settlement entity to ensure that the worst case loss of the central counterparty 100 is backed by sufficient collateral. In the event that the collateral limit is exceeded, the clearing and netting system 103 may instruct the rest of the central counterparty 100 to cause trading to cease for that entity or for any trading entity whose settlements are guaranteed (cleared) by the entity whose limit has been exceeded. Alternatively, the central counterparty 100 may only accept trades which reduce settlement exposure (i.e. which liquidate positions) for entities whose settlement limit has been exceeded, as opposed to cessation of all trading for that entity.

Next, settlement system 104 may receive net settlement instructions from both the clearing and netting system 103 and from individual settlement applications 109. The settlement system 104 can then confirm that the net settlement information from the clearing and netting system 103 and the settlement applications 109 agree.

For all settlements scheduled for a future date, including settlements from multi-settlement transactions, at least one of the clearing and netting system 103 and the settlement system 104 may determine possible losses to the central counterparty 100 if these transactions should fail to settle. The central counterparty 100 may then ensure sufficient collateral is maintained to cover such losses. This process and computation may occur periodically during the time period prior to settlement.

In at least one illustrative implementation of the system of FIG. 1, the system may include computers, stored programs, and communications networks and be operated so as to not require manual intervention under normal trading operations. Accordingly, this illustrative invitation of the system of FIG. 1 may allow fast and efficient trading and settlement of transactions in markets that were previously limited by significant counterparty risk by significantly minimizing and/or eliminating counterparty risk from all market participants.

FIG. 11 shows a functional block diagram of an illustrative example of a computerized entity 1100 of the system of FIG. 1, such as a server, a computer system, a terminal or other computerized entity hosting one or more of the trader applications 106-109, the clearing applications 113, the settlement system 104, or the central counterparty system 100, including the control system 101, the transaction matching system 102, and/or the clearing and netting system 103. As shown, computerized entity 1100 includes one or more processors 1102 connected to one or more interfaces 1104 (e.g. a network interface, a wireless communications interface, etc.), memory 1106, and storage 1110. Stored within memory 1106 are computer applications/software 1108 that provide instructions to one or more processors 1102 for enabling computerized entity 1100 to perform various functions, such as those described herein for the components of the system of FIG. 1. Although shown as part of computerized entity 1100, storage 1110 could be remote storage connected to computerized entity 1100. Further, although shown as a single entity, computerized entity 1100 could be a group of interfaced entities, such as a group of network-connected servers.

The minimization and/or elimination of counterparty risk from all market participants is important. Otherwise, counterparty risk for trading existing OTC products would be borne by the participants in the marketplace. Examples of OTC products include but are not limited to Foreign Exchange, Interest Rate Derivatives, Bonds, Credit Derivatives, and others. Elimination of counterparty risk, or more properly transference of this risk away from market participants, can provide a number of benefits to the marketplace:
1. A high level of market transparency and level playing field: since the marketplace has no counterparty trade risk, there is no counterparty trade limitation. This means that all bids and offers are available to all participants, thereby creating a highly transparent market and a level playing field for all participants.
2. Full participation: since there is no direct settlement in the marketplace, there is no restriction on the class of entities who can participate. For instance, the marketplace may be accessible by banks, brokers, institutions, corporations, funds, and individuals where previous OTC markets were limited to a select group of banks, brokers, and trading houses.
3. Complete anonymity: there is never a need to know with whom one has traded, since there is no direct post-trade relationship between the buyer and the seller.
4. Trade certainty: all trades are guaranteed to be scheduled for settlement, since there is no possibility of one side of the trade failing to confirm and thereby breaking the trade.
5. Settlement certainty: all trades are guaranteed to settle on the specified settlement day or days, since settlement is not dependant upon the actions of a counterparty.

One or more of the above effects may be realized when all counterparty risks (which may occur as a result of the failure of any market participant) are transferred away from the participants in the marketplace. The central counterparty 100 that operates the marketplace may then be in a better position to control and/or manage the counterparty risks. The central counterparty 100 may include various systems to manage the scale and magnitude of the counterparty risk, and place appropriate safeguards into operation to ensure the counterparty risk is within acceptable limits.

The above functional elements are now described in greater detail.

FIG. 2 shows various message flows and interfaces in accordance with aspects of the present invention. In FIG. 2, transaction matching system 204 transmits order book updates to trading access API 203. The order book is then transmitted to the trader application 202, and the order book displayed for a trader on market GUI display 201. In response to the order book displayed on the market GUI display 201, the trader sends order messages to transaction matching system 204 via trading access API 203. The transaction matching system 204 may send a number of responses to the trader application 202 via the trading access API 203.

The transaction matching system 204 then attempts to match trades. The transaction matching system 204 then forwards matched trades to clearing and netting system 205. The clearing and netting system 205 may then can communicate with settlement application 206 to ensure the settlement application 206 is notified of the matched trade received from the transaction matching system 204. This may generally happen once or more per settlement day. In some markets, it may be desirable to forgo netting and notify the settlement system and settlement system of each individual trade for settlement.

The clearing and netting system 205 may also determine a level of counterparty risk associated with a trade. The risk may then be managed by collateral management system 208. If a trader's credit (or his institution's credit) has been exceeded by a trade, then the clearing and netting system 205 informs the transaction matching system 204 that the trader's credit level has been exceeded. The transaction matching system 204 may take several possible actions, including (a) not accept the trade, or (b) cancel the trade, or (c) automatically obtain additional collateral from the trader or trading entity associated with the trader, or (d) cease all trading for the entity and cancel its open unfilled orders, or (e) only allow the trading entity to enter orders to liquidate positions, or any combination of the above.

The clearing and netting system 205 may exchange net settlement information with the settlement application 206 in order to provide the settlement application 206 with an update of a trader or trading entity's current net settlement position and collateral status. The clearing and netting system 205 and transaction matching system 204 may obtain additional collateral from trader or trading entity associated with the trader. Obtaining the additional collateral may be done directly or indirectly through another entity, for instance. If the trade has been approved by the clearing and netting system 205, the clearing and netting system 205 novates the trades and interposes itself between the counterparties.

Next, net settlement instructions are sent from both clearing and netting system 205 and settlement applications 206 (associated with the parties to the transaction) to settlement system 207, where settlement is eventually performed. This may be performed at the end of a trading session or possibly more times during the trading session. One may opt for notification on a per-trade basis and forgo a netting opportunity.

Finally, the transactions matching system 204 provides order book updates to trader applications 202 through trading access API 203, so as to inform the traders of the new market position.

FIG. 3 shows various message flows and interfaces regarding order validation, matching, and order book updating in accordance with aspects of the present invention. FIG. 3 shows trader terminal display and input 301, which receives a trader's order messages. The transaction matching system receives the new order in step 302. Optionally, the order may be recorded in an audit trail database 303 (as shown in broken lines).

Next, the transaction matching system may optionally attempt to validate the order message from the trader in step 304. If all the message fields are valid, the message may then be inserted into the limit order book in a price/time priority order as shown in step 306. If not, the transaction matching system may send an order rejection message to the trader as shown in step 305. This order rejection message may be a trader direct message (as it is sent directly to the trader). The order might be rejected if the trading activity from the relevant entity has been halted due to a limit being exceeded (“Stop Trading Control” from step 318).

From step 306, a number of additional steps may be performed. These additional steps may be performed simultaneously or in various orders as described herein. In step 309, the transaction matching system generates a trigger for matching. The trigger may be a flag or other identifier or event that requires the system to handle at a later point.

The transactions matching system may then perform matching on the limit order book as shown in step 314. In step 315 the transaction matching system determines if any trades are identified. If trades are identified, then in step 316 the system sends a matched trade message to the clearing system 317 (also referred to above as the clearing and netting system).

The transaction matching system next receives from clearing system 317 messages indicating that a credit level for a trader has been exceeded (message 318). The trade matching system interprets the credit exceeded message 318 as a stop trading control message.

The credit exceeded message 318 may pertain to a trader who recently sent the order message or may pertain to a trader whose order message was posted in the order limit book. Depending on which trader lacks sufficient credit or collateral, the transaction matching system may forward an indication to the trader that lacks sufficient credit.

The trade matching system may then return to the validation step 304 or the insert order into the limit book step 306 for the order message pertaining to the trader with sufficient credit.

Alternatively, the trade matching system may receive novated trades from the clearing system 317 in step 319. The trade matching system may then send trade affirmation messages to the trader applications in step 320.

From step 306, the system may update the limit order book 308 and perform matching operations on limit order book 308 in step 314.

From step 315, whether or not any trades were identified, the system in step 310 generates a trigger for generating broadcast update messages to the limit order book 308. This trigger may be saved for a later date and the transaction matching system proceeding directly to step 311. Alternatively, the transaction matching system may determine if the order message changes the best book in step 312. If the best book is not modified, then the transaction matching system finishes in step 311. Alternatively, the transaction matching system sends book update messages to the trader applications 301 on the network in step 313. This may take the form of a network broadcast message. With the broadcast of the book update message from step 313, the transaction matching system finishes in step 311.

Generally, a matching system operates on an order-by-order basis, i.e. each order is evaluated for possible matches and possible order book updates, so steps 309 and 310 would not be implemented. The sequence would be (a) insert order into order book 308, (b) execute all possible trades (step 314), (c) determine what book updates are required (step 315) and send update messages (step 316). However, in some high-volume markets, the order-by-order processing is too demanding of computational and network capacity, so the system may be implemented to match (step 309), say once per second, and send out book updates two or three times per second (step 310). In these cases, a trigger is set to cause the periodic processes to execute in steps 309 and 310.

Finally, from step 306, the transaction matching system may send a message to the trader 301 in step 307 that the trader's order has been accepted.

FIG. 4 shows various message flows relating to matched trade novation with settlement limit control in accordance with aspects of the present invention. In step 401, a clearing system receives a matched trade message from the trade matching system. Optionally, the clearing system may record the matched trade message in an audit trail database 402.

In step 403, the clearing system may validate the matched trade data. If the clearing system cannot validate the matched trade message (including by reference to the data fields, formats, range checks, and other data validation), the clearing system sends a matched trade rejected message to the matching system in step 404, which may then be entered in a message queue 405 holding messages for the matching system.

If the clearing system is able to validate the matching systems matched trade data, then the clearing system records the matched trade message in the audit trail database 402. Next, the clearing system checks whether pre-novation credit controls are enabled in step 407. Such pre-novation credit controls may be enabled on a per-instrument, per settlement date, per settlement entity, or other basis. For example it may be desirable to perform pre-novation credit control checks on all trades over a certain gross size, or on all trades for settlement in more than 30 days, or for all trades guaranteed by entities in a certain country. If pre-novation credit controls are not enabled for the current trade, the clearing system sends a matched trade accepted message to the matching system in step 408 by inserting it into the matching system message queue 405.

If the pre-novation credit controls are enabled as checked in step 407, the clearing system identifies the guarantor clearing member from a default list or from the message data from the trade matching system in step 409. Next, the clearing system determines if the current matched trade exceeds a credit limit for the trader in step 410. If the credit limits were not exceeded from step for 410, the clearing system then sends the matched trade accepted message to the matching system in step 408. Alternatively, if the credit level was exceeded, then the clearing system sends a matched trade rejected message (e.g., credit exceeded message) to the matching system in step 411. The matched trade rejected message may then be inserted into matching system message queue 405. A clearing member and credit controls database for 412 may provide a default list of guarantor clearing members for traders and/or credit limits for the traders and/or trading entities.

FIG. 5 shows an illustrative example of various message flows in accordance with pre-settlement trade netting with trade substitution in accordance with aspects of the present invention.

In general, pre-settlement netting typically is executed according to a schedule of events that is determined, in part by the requirements of the external settlement system. Settlement systems may accept trades for settlement for a given date, but only within a specified window of time. For instance, two trades may be executed on a given day: one at 3 pm New York time and the other at 8 pm, New York time. While both trades occurred on the same day, they may settle on different days because of the designated settlement system for both trades may have a settlement window that was open for the first trade but closed for the second, thereby pushing the second settlement to the next settlement day. The pre-settlement netting system processes trades in accordance with the requirements of the settlement systems. Based on these requirements, the netting system performs its netting computations and sends messages to settlement entities and the external settlement system.

FIG. 5 shows an illustrative example of a pre-settlement trade netting and trade substitution process. In step 501, a netting system receives a message regarding a settlement window open time and a settlement window close time for a settlement system. This message may be sent on a regular basis or may be a known window based on previous information from the settlement system. Next in step 502, the netting system continually monitors the date and time and triggers on the settlement window open time. Next, in step 503, the netting system selects all trades by instrument, by settlement date, by settlement entity, and by a net settlement indicator (that a party wanted to settle in net, not gross), for instance.

Here, pre-settlement netting may be performed on a per instrument, per settlement date, per settlement entity basis, only for those trades marked for net settlement (as opposed to gross settlement).

Next, in step 504, for each instrument, date, settlement entity, the netting system may compute the sum of amounts for each asset being settled (asset 1, asset 2, . . . ). All amounts may be netted with positive amounts received by the central counterparty and negative amounts paid by the central counterparty.

Next in step 505, the netting system replaces all individual (netted) settlements with a single net settlement.

From step 505, the netting system may perform net settlement substitution, thereby novating trades in step 507. The netting system then sends a net settlement message to the relevant clearing entities in step 508.

Additionally, the system may determine if additional instruments need to be addressed in step 506. If yes, the system then returns to step 503 to handle the additional instruments. If not, the system continues to step 508. Here, it is noted that steps 506 and 507 may be performed in parallel or serially with either step preceding the other. Further, step 506 may occur after step 508 in an alternative example.

In yet a further example, the set of trades may be netted down to a single profit or loss value as opposed to a net transaction as handled by step 508. For instance, the profit or loss may be settled outside the settlement system. In this regard, net settlements may be handled by the settlement system described above and singular profit or loss amounts may be settled in a separate system.

Automated settlement and netting may be assisted when the received messages regarding the instruments and other information are consistent. For instance, every instrument may indicate its preferred settlement method and settlement institution for sample, this information in a US dollar Japanese yen spot market may appear as follows:
USD/JPY Spot (Instrument), Settlement Method (Cash), Settlement Institution (ABC Bank)

Also, every trade may have one or more settlements. For example, messages pertaining to a trade may appear as follows:
USD/JPY Spot settles on Trade Date+2 (subject to holidays and weekends)
EUR/USD 1 Month has a Spot Settlement and a Forward Settlement

Every settlement may have a settlement date, a specification of assets, and settlement amounts. For sample messages pertaining to a settlement may appear as follows:
USD/JPY Spot Settlement, Date=Apr. 4, 2006,
Asset 1=USD, Asset 2=JPY,
Settlement Amt 1=10,000,000, Settlement Amt 2=−120,000,000
Positive Settlement Amounts are Received by the Central Counter Party,
Negative Settlement Amounts are Paid by the Central Counter Party

Next, the settlements may be specified to settle in net or in gross.

Further, the settlement institutions may have a Window Open Time and a Window Close Time for each Settlement Date.

Moreover, Net Settlement Processing may be triggered by the end of trading for a particular Settlement Date for a particular Instrument.

Finally, a Value Date Rollover Time may be specified to be no later than a Window Open Time for a particular Instrument.

### 6. Trader API

FIG. 6 shows an application programming interface and trader terminal that may be used in accordance with aspects of the present invention. An illustrative trader terminal 607 may be a processing device that provides an interface for a trader and includes some type of hardware interface device or devices 609 (keyboard, mouse, trackball, microphone with voice recognition software, and the like).

Also, the trader terminal 607 may be an automated terminal that does not have a user interface but only handle transactions in an automated fashion for a trader. The trader terminal 607 may not be a “terminal” in the traditional sense, but rather may be a software application which performs automated trading based on rules embodied in its software (so-called “black-box” proprietary trading).

The trader terminal 607 may exchange messages with other components of the system through network 601 using application programming interfaces 602. The application programming interfaces may include, but are not limited to, the following. First, market information 603 may be provided to the trader terminal 607 for display on display 608. The market information may be transmitted in various ways including only as a singular book, a book followed by incremental updates to the book, and the like. The display of market information may include the order book, trades in the market, price history, high and low prices for instruments, and associated volumes.

Next, API 602 supports order entry capabilities 604 that allow a trader to create order messages to be transmitted to the network 601. The order entry functions may include entering limit orders, entering market orders, entering spread orders, entering contingent orders, and canceling of previously submitted Orders.

Further, API 602 may include the handling of trade reports 605. The handling of trade reports 605 may include information that flows upstream from the trader terminal 607 to the network 601 specifying which report or types of reports are desired and/or the delivery of the reports. The reports may be static or dynamic (receiving real-time information from a remote source and incorporating it into the information displayed to a trader) as is known in the art. For instance, the reports may include information regarding executed orders and fulfillment of settlement obligation summaries.

Finally, API 602 may include support for additional applications 606 that may aid the trader in understanding new market information and additionally executing trades in the system. The additional applications may include applications that provide analytical information or charts to automated trading programs and/or algorithmic trading programs. Further, the additional applications may provide analytical tools for the traders.

### 7. Transaction Matching

FIG. 7 shows various functional components of the transaction matching system in accordance with aspects of the present invention. The transaction matching system may include any user authentication module 701 that authenticates a user to the transaction matching system and possibly the rest of the central counterparty system. The user authentication may validate the user's identity, and organizational identity to which the user is associated, and the settlement agent to be associated with the user.

The transaction matching system may also include an order processing module 702 that processes received order messages. The processing of received orders may include recording the receipt of the message in a database, validation of the order, and other steps. The order processing module handles new orders as well as cancellations of existing orders.

The transaction matching system may also include a book management module 704 that includes a book update component 705. The book management module 704 may manage the order book as seen by the various traders. The book update component 705 may handle the generation and forwarding of messages to the various traders across the network.

The transaction matching system may further include a transaction processing module 706 that handles matched trades and the exchange of these matched trades and subsequent novated trades with the clearing and netting system 707.

### 8. Clearing and Netting

FIG. 8 shows clearing and netting components in accordance with aspects of the present invention. The clearing and netting system may receive matched trade notifications in module 802 from matching system 801. The clearing and netting system may also confirm receipt back to the matching system 801.

The clearing and netting system may include a trade novation module 803 that may determine and generate all settlement details 804, handle the assignment of net/gross settlement amounts 805, and generate trade confirmation messages 806 for settlement agents of the trading parties. The clearing and netting system may include a risk management module 807 that provides information regarding settlement positions 812, and analysis 813 of the maximum loss that may be borne by for instance the central counterparty per instrument per date, and risk mitigations 814 that may require more or less credit or collateral from a trader.

The clearing and netting system may further include a pre-settlement netting module 808 that provides a novation of all trades into a net trade 807 for each trader and provides a final net settlement position 815. Finally, the pre-settlement netting module may output settlement information to settlement applications 1-N 809-811.

In some aspects of the invention, the clearing and netting system may be capable of performing clearing and netting without human intervention in most situations.

### 9. System-Associated Settlement System

FIG. 9 shows a settlement system in accordance with aspects of the present invention. The settlement system 901 may make payment 1 902 and receive payment 2 903 from the trading parties. The settlement system 901 may also transmit funding messages 904 informing market participants of their funding status. Further, the settlement system 901 may also transmit settlement messages 905 to settlement applications associated with the trading entities.

In some aspects of the invention, the settlement system may be capable of performing settlement without human intervention in most situations, thereby streamlining the settlement process.

### 10. Trader-Associated Settlement Application

FIG. 10 shows a settlement application in accordance with aspects of the present invention. Settlement application 1001 may be associated with the trading entities or designated by the trading entities to handle their settlements. The settlement application 1001 may be an automated system that continually receives trade confirmation messages 1002 and computes net-settlement positions based on predefined defaults and indicators. At the close of each trading day, as notified by the central clearing system for example, the settlement application 1001 determines net and/or gross settlement information. This information may then be exchanged with the central counter party. If all relevant values match, then the settlement information is sent as settlement instructions 1004 to a clearing and netting system and/or a settlement system associated with the central counterparty or even an external settlement system. The settlement application 1001 may then receive a receipt of the completed settlements 1005. Finally, the settlement application 1001 receives net settlement messages 1003 that indicate, among other things, the net transaction details and payment amounts.

In some aspects of the invention, the trader-associated settlement applications may be capable of performing settlement with the settlement system above without human intervention in most situations, thereby streamlining the settlement process for traders.

### 11. EXAMPLES

The following are illustrative examples of net versus gross settlement indicators with the central counterparty.

The first set of illustrative examples applies to transactions in Foreign Exchange (FX) products. Specifically, the business rationale for gross versus net settlement is illustrated in the Spot FX, Forward FX, and FX Options markets.

### Example 1

The treasury department of a commercial bank provides FX transaction services to corporate customers.

In this example, a commercial bank is the user of the central counter party FX trading service, and enters orders into the marketplace on behalf of its commercial customers. The customers of the bank are typically not banks or financial institutions themselves (although they could be); in this example the customers of the bank are corporations with foreign exchange exposures. For example, a corporation who sells finished products to foreign customers, and who is paid in foreign currencies, may need to convert those payments back into its domestic currency, and will utilize the FX transaction services of its commercial bank to do so. Another case might be where a commercial producer of goods purchases raw materials from a foreign source, and needs to pay in foreign currency. In this case the producer may want to “lock in” an FX rate for future purchases and thereby avoid the volatility and risk of fluctuating FX rates.

The commercial bank will typically have a large number of corporate customers, varying in size and trading frequency. The largest customers may engage in multiple FX transactions every day (e.g. if they actively hedge FX exposures). Smaller customers may engage in an FX transaction as infrequently as once a month.

There are many cases where a corporate customer will enter into an FX transaction which requires actual delivery of foreign funds. For example, the customer has received a payment in Japanese Yen, credited to its Japanese bank account, and wishes to convert this payment into US Dollars as soon as practical. In this case the corporate will phone its bank, and request to SELL JPY and BUY USD for spot delivery. The bank must ensure that this transaction is NOT subject to netting, otherwise the required currency may not be available for the corporate customer on spot delivery day.

In other cases, the corporate customer may wish that certain transactions be netted for settlement purposes. For example, a US corporate is expecting to purchase raw materials from a French producer in six months, and to pay Euro for this purchase. The corporate does not want to be subject to the possibility that the value of the Euro will fluctuate against the USD during these six months. To hedge against the fluctuation the corporate may enter into two transactions: a Spot purchase of Euros, and a Forward Swap sale of Euros. The spot purchase of Euros locks in the Euro/USD exchange rate today, and the forward swap liquidates the spot settlement and “rolls” the purchase into the six month forward date. Note that an FX Forward Swap is a Spot Transaction and a Forward Transaction in the same amounts, opposite directions, with the rates linked by interest rate differentials. In effect, the corporate has purchased the Euros for delivery in six months, and locked in today's Spot rate and today's interest rate differentials.

In order for this hedge to be most effective, the corporate will want to Net Settle the two spot transactions (thereby netting them to zero) and be left with the single forward transaction. The table below illustrates these two transactions:

| | | | | Settlement |
|---|---|---|---|---|
| | EUR | USD | Rate | Date |
| Transaction | | | | |
| 1 | | | | |
| Spot | +1,000,000 (B) | −1,257,000 (S) | 1.2570 | 21 Jun. 2006 |
| Transaction | | | | |
| 2 | | | | |
| | −1,000,000 (S) | +1,257,000 (B) | 1.2570 | 21 Jun. 2006 |
| 6 Month | +1,000,000 (B) | −1,272,000 (S) | 1.2720 | 21 Dec 2006 |
| Swap | | | | |
| NET | 0 | 0 | | 21 Jun. 2006 |
| SETTLE | | | | |
| | +1,000,000 (B) | −1,272,000 (S) | 1.2720 | 21 Dec 2006 |

As the table above illustrates, Transaction 1 is a Spot purchase (B) of Euros against a sale (S) of US Dollars. This locks in a Spot rate of 1.2570. Transaction 2 “rolls” this Spot exposure six months forward through a 6 Month Spot/Forward Swap. The Swap sells the Euros in Spot, and purchases them back in 6 months. The 6 month rate is determined by today's Spot rate and the 6 month interest rate differential for deposits of the two currencies.

The NET SETTLEMENT of these two transactions results in a single outright forward purchase of Euros and sale of USD based on today's Spot Rate.

In order to achieve this effect the commercial bank must indicate that the two transactions are to be Net Settled, thereby neutralizing the spot settlement position. In fact, the commercial bank may want to place these two transactions into an isolated account for net settlement to indicate that they should settle net with each other, but not net against any other nettable transactions.

Thus, the demands of commercial banking dictate that users of a net-gross settlement facility should be able to indicate, on a transaction by transaction basis, which transactions are eligible for Net Settlement and which for Gross Settlement. Furthermore, the commercial bank may need to identify sets of transactions, for example from a single customer, which may be net with each other but not with other net settled transactions.

### Example 2

This example relates to the proprietary trading operation of a bank treasury department, trading in multiple asset classes.

In this example, the treasury department of a large bank has an internal proprietary trading desk (so-called “prop trading”), which operates as if it were an internal hedge fund. It is actively involved in trading foreign equities and bonds, and in trading FX as a distinct asset class.

The trading for foreign securities generally involves an associated foreign exchange transaction. For example, if a fund purchases Japanese equities worth 100 million Yen, it will need to fund this purchase by acquiring the JPY on or before the settlement date for the equity trade. If a USD-based fund owns a position in Euro denominated bonds, and it sells those bonds, it may wish to repatriate the Euros into US Dollars on the settlement date. Finally, a fund which owns a position in Euro bonds may want to regularly repatriate the interest payments (the coupon) of that bond when it is paid twice of four times a year.

In all of these examples, a transaction in a foreign security (bond or stock) resulted in a need to transact in the FX market to convert one currency to another. The transaction must actually deliver the required currency, particularly if it is being used to fund a security settlement (you obviously cannot net payments across different brokers or exchanges). Hence, most of these security trade-related FX transactions will require GROSS settlement.

However, if the fund also actively trades FX as a distinct asset class (i.e. not associated with an underlying trade in some other asset), then it will generally want to NET all settlements of resulting trades. For example, the prop trading strategy may involve a “momentum trading” algorithm which provides buy and sell signals throughout the trading day based on short-term trading patterns. These signals then result in multiple Buy and Sell transactions in a single currency pair, e.g. EUR/USD, which are executed using a software program. This entire process, also known as “algorithmic trading” can result in hundreds of transactions in the course of a single day, and very often these transactions all net down to a single profit (or possibly loss) for the fund. They are all netted into a single settlement.

Thus, the example of a proprietary trading desk illustrates the need for a single user of the system to designate some trades as gross settled and others as net settled.

### Example 3

This example relates to non-FX transactions subject to net settlement.

In this example, transactions outside the realm of Foreign Exchange are highlighted. These transactions illustrate the benefits of a Gross-Net Settlement indicator with a central counterparty (CCP). Specifically, interest rate derivatives (IRD's) including Forward Rate Agreements (FRA's) and Interest Rate Swaps (IRS's) are used in this example.

A Forward Rate Agreement is essentially a hedge on a term interest rate for a period beginning at some point in the future. For example, suppose a corporation knows that in three months it will need to borrow $10,000,000 for six months to fund its operations. In other words, it will be taking a six month loan at a point three months in the future. Borrowing rates are almost always based on some differential over an “Interbank rate” such as LIBOR or EURIBOR. The corporation knows that it will pay, for example, “one point over LIBOR” but it does not know, today, what six-month LIBOR will be in three months time. So, to manage this risk, it enters into what is known as a “3×9 USD FRA” which is read as a “three by nine US Dollar Forward Rate Agreement”. The 3×9 means that the FRA will settle in 3 months time and be looking at the rate for six months (9-3) at that time.

At the time the FRA is transacted, the buyer and seller agree on an interest rate, which is the rate they expect six month LIBOR to reach in three months time. After three months, the rate agreed in the transaction is compared with actual six month LIBOR (or fed funds, or some other agreed benchmark), and any difference between the rate of the FRA and the benchmark is exchanged between the parties to the transaction. In the case of trading with a CCP the exchange of value is with the central counterparty, not the other party to the trade.

Unlike an FX transaction, the FRA involves payment of a single currency from one party to another, as opposed to the exchange of two currencies.

An Interest Rate Swap is a series of back-to-back FRA's. For example, the issuer of a fixed coupon bond has an obligation to pay its bondholders a fixed interest rate two or four times a year. Say, for example, a ten year bond has a 5% coupon payable on a quarterly basis, and suppose the bond issuer has sold $100 million of these bonds. In this example the bond issuer needs to pay the bond holders $1.25 million per quarter for the next ten years. Suppose, additionally, that the bond issuer typically funds its business by short term borrowing based on LIBOR. In this case it may be in the interest of the bond issuer to enter into a Fixed/Floating ten year “plain vanilla” interest rate swap where the bond issuer pays floating and receives fixed. By receiving fixed, the bond issuer knows that its 5% coupon payments will be fully hedged. By paying floating it knows that its costs will be indexed to its borrowing costs. This ten year transaction is logically equivalent to a series of forty 3 month FRA's.

Since the FRA or IRS settlements are essentially the payment of the mark-to-market difference between the rates agreed at transaction time and the rates prevailing at settlement time, there is no underlying commercial need to gross settle these payments. In many cases, if there is an opportunity to net the single-currency settlement of an FRA or IRS with the settlement obligations of other transactions at the same date, then the overall operational complexity of settlement will be reduced.

FRA's and IRS's may also be used as a component of an FX trading strategy. Since foreign exchange rates are fundamentally tied to underlying interest rates, it is possible to enter into an FX position whose value will vary dramatically if the associated interest rates move. To hedge, or to profit from these interest rate movements an FRA or IRS position may be entered into as part of the FX strategy. For example, if one believes that low USD interest rates will spur growth of the US economy and result in superior performance for US equities, then one may believe that the US dollar will appreciate in value over the Euro as demand for USD denominated investments increases. This trading strategy is to hold a short EUR/USD six month position (i.e. long dollars, short euro) in expectation that the spot EUR/USD rate will weaken as the USD strengthens over six months. However, an adverse movement in USD interest rates (i.e. raising of the fed funds rate) could thoroughly undermine this position. To hedge against this, one could enter into a 1×7 FRA to essentially fix the USD interest rate at the point it is today, and any loss in my FX position would be offset by a gain in one's FRA position. Clearly, in this example, net settlement of the related transactions would be preferable to gross settlement of the separate parts.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Numerous other embodiments, modifications, and variations within the scope and spirit of the appended claims will occur to persons of ordinary skill in the art from a review of this disclosure.

What is claimed is:

1. A net settlement computing entity of an intermediary system, the net settlement computing entity comprising:
memory for storing computer readable instructions;
one or more network interfaces; and
one or more computer processors in communication with the one or more network interfaces and the memory, the one or more computer processors configured to perform steps including:
receiving data identifying a plurality of matched trades, each matched trade being between a pair of counterparties for a financial instrument, each matched trade having a settlement date, a quantity and a price;
novating each matched trade into a first novated trade between the intermediary system and a first counterparty of the pair of counterparties and a second novated trade between the intermediary system and a second counterparty of the pair of counterparties, the first novated trade and the second novated trade each maintaining the settlement date, the quantity and the price for the financial instrument of the corresponding matched trade;
identifying currently-qualified trades of the first and second novated trades that currently qualify for post-trade pre-settlement netting based on criteria including their settlement date; and
performing post-trade pre-settlement netting for the currently-qualified trades, the step of performing including:
selecting a first set of trades for netting from the currently-qualified trades based on a first selection criteria, the first selection criteria including a first settlement counterparty for a first one of the currently-qualified trades and a first financial instrument of the first currently-qualified trade;
calculating, from the first set of trades, a net trade for the first settlement counterparty and the first financial instrument; and
substituting the first set of trades with the net trade.

2. The net settlement computing entity of claim 1, wherein the step of performing post-trade pre-settlement netting includes, repeating the steps of selecting, calculating and substituting based on additional sets of selection criteria, the additional sets of selection criteria including:
(a) each financial instrument of the currently-qualified trades that is traded by the first settlement counterparty of the first set of criteria;
(b) each counterparty of the currently-qualified trades in addition to the first settlement counterparty for a second financial instrument, the second financial instrument being the same or different than the first financial instrument; and
(c) each financial instrument of the currently-qualified trades that is traded by each counterparty of group (b) in addition to the second financial instrument.

3. The net settlement computing entity of claim 1, wherein the step of performing post-trade pre-settlement netting includes sending information for the net trade to a clearing entity.

4. The net settlement computing entity of claim 1, wherein the step of performing post-trade pre-settlement netting includes sending information for the net trade to the first settlement counterparty.

5. The net settlement computing entity according to claim 1, wherein:
for the step of receiving data, the data for each matched trade includes a pair of net-indicators, each net-indicator being associated with a counterparty of the matched trade and indicating whether the associated counterparty desires net settlement for the matched trade;
the step of novating includes relating the net-indicator associated with each of the first and second counterparties with the corresponding novated trade to identify whether the novated trade is net-eligible; and
for the step of identifying currently-qualified trades of the first and second novated trades, the criteria includes their net-indicator.

6. The net settlement computing entity of claim 5, wherein the net-indicator may be a default net indicator for the associated counterparty.

7. The net settlement computing entity of claim 6, wherein the default net indicator corresponds with a financial instrument pre-selected by the associated counterparty.

8. The net settlement computing entity of claim 6, wherein the default net indicator has a default condition of net settlement.

9. The net settlement computing entity of claim 6, wherein the default net indicator has a default condition of gross settlement.

10. The net settlement computing entity of claim 6, wherein each net-indicator can be changed by the associated counterparty prior to the step of performing post-trade pre-settlement netting for the novated trade corresponding with the net-indicator.

11. The net settlement computing entity of claim 5, wherein each net-indicator can be set by the associated counterparty independently of another counterparty.

12. A method for transferring counterparty risk in financial transactions, the method comprising:
receiving, at an intermediary system, data identifying a plurality of matched trades, each matched trade being between a pair of counterparties for a financial instrument, each matched trade having a settlement date, a quantity and a price;
novating each matched trade into a first novated trade between the intermediary system and a first counterparty of the pair of counterparties and a second novated trade between the intermediary system and a second counterparty of the pair of counterparties, the first novated trade and the second novated trade each maintaining the settlement date, the quantity and the price for the financial instrument of the corresponding matched trade;
identifying currently-qualified trades of the first and second novated trades that currently qualify for post-trade pre-settlement netting based on criteria including their settlement date; and
performing post-trade pre-settlement netting for the currently-qualified trades, the step of performing including:
selecting a first set of trades for netting from the currently-qualified trades based on a first selection criteria, the first selection criteria including a first settlement counterparty for a first one of the currently-qualified trades and a first financial instrument of the first currently-qualified trade;
calculating, from the first set of trades, a net trade for the first settlement counterparty and the first financial instrument; and
substituting the first set of trades with the net trade.

13. The method of claim 12, wherein the step of performing post-trade pre-settlement netting includes, repeating the steps of selecting, calculating and substituting based on additional sets of selection criteria, the additional sets of selection criteria including:
(a) each financial instrument of the currently-qualified trades that is traded by the first settlement counterparty of the first set of criteria;
(b) each counterparty of the currently-qualified trades in addition to the first settlement counterparty for a second financial instrument, the second financial instrument being the same or different than the first financial instrument; and
(c) each financial instrument of the currently-qualified trades that is traded by each counterparty of group (b) in addition to the second financial instrument.

14. The method of claim 12, wherein the step of performing post-trade pre-settlement netting includes sending information for the net trade to a clearing entity.

15. The method of claim 12, wherein the step of performing post-trade pre-settlement netting includes sending information for the net trade to the first settlement counterparty.

16. The method according to claim 12, wherein:
for the step of receiving data, the data for each matched trade includes a pair of net-indicators, each net-indicator being associated with a counterparty of the matched trade and indicating whether the associated counterparty desires net settlement for the matched trade;
the step of novating includes relating the net-indicator associated with each of the first and second counterparties with the corresponding novated trade to identify whether the novated trade is net-eligible; and
for the step of identifying currently-qualified trades of the first and second novated trades, the criteria includes their net-indicator.

17. The method of claim 16, wherein the net-indicator may be a default net indicator for the associated counterparty.

18. The method of claim 17, wherein the default net indicator corresponds with a financial instrument pre-selected by the associated counterparty.

19. The method of claim 17, wherein the default net indicator has a default condition of net settlement.

20. The method of claim 17, wherein the default net indicator has a default condition of gross settlement.

21. The method of claim 17, wherein each net-indicator can be changed by the associated counterparty prior to the step of performing post-trade pre-settlement netting for the novated trade corresponding with the net-indicator.

22. The method of claim 16, wherein each net-indicator can be set by the associated counterparty independently of another counterparty.

23. A method for transferring counterparty risk in financial transactions, the method comprising:
receiving at a clearing and netting system data identifying a plurality of matched trades between two or more counterparties for a financial instrument;
novating each of said matched trades into separate trades between a central counterparty and each of said two or more counterparties;
performing pre-settlement netting for said counterparties; and
forwarding to a settlement system settlement information including information regarding at least said separate trades, where the separate trades are settled between said central counterparty and each of said two or more counterparties.

24. The method according to claim 23, wherein said settlement system is able to perform payment verses payment settlement based on said forwarded settlement information.

25. The method according to claim 23, wherein said method is capable of settling without human intervention.

26. A system for effecting trades between a first counterparty and a second counterparty where a matched but unsettled trade exists between the first and second counterparties comprising:
a clearing and netting system that novates said matched but unsettled trade and interposes itself such that said matched trade is replaced by a first transaction between said first counter party and said clearing and netting system and a second transaction between said second counterparty and said clearing and netting system; and
a settlement system that settles said first transaction and said second transaction.

27. The system according to claim 26, wherein said clearing and netting system obtains additional credit from one of said first and second counterparties prior to novating said matched but unsettled trade.

28. The system according to claim 26, wherein said settlement system settles one said transactions between one of said counterparties and said clearing and matching system in gross or in net with other transactions as specified by said one of said counterparties.
